(19) United States
(12) Patent Application Publication
(10) Pub. No.: US 2022/0112331 A1
(43) Pub. Date: Apr. 14, 2022

(54) CATIONICALLY CURABLE COMPOSITIONS

(71) Applicant: 3M INNOVATIVE PROPERTIES COMPANY, St. Paul, MN (US)

(72) Inventors: Wayne S. Mahoney, St. Paul, MN (US); Pamela A. Percha, Woodbury, MN (US)

(21) Appl. No.: 17/423,587

(22) PCT Filed: Jan. 31, 2020
(86) PCT No.: PCT/IB2020/050801

§ 371 Date: Jul. 16, 2021

Related U.S. Application Data
(60) Provisional application No. 62/801,728, filed on Feb. 6, 2019.

(51) Int. Cl. C08G 59/68; C08K 5/14; C08K 5/07; C08K 5/05; B01J 31/12; C08K 5/00; C08G 59/06; C07F 17/02

(52) U.S. Cl. CPC C08G 59/68; C08K 5/14; C08K 5/07; C07F 17/02; B01J 31/12; C08K 5/0025; C08G 59/063; C08K 5/05

(57) ABSTRACT

Described is a cationic initiator system comprising a cationic initiator; and an accelerator composition comprising 1) a operoxyketal; and 2) an accelerator compound selected from arylhydroxy compounds and β-diketone compounds.

### FIELD OF INVENTION

This invention relates to polymerizable compositions comprising a cationically curable material; energy-polymerizable compositions that comprise a cationically curable material and an initiator system, which initiator system comprises at least one cationic initiator and an accelerator component; and a method for curing the compositions. This invention also relates to preparing articles comprising the cured compositions. In addition to other uses, the compositions are useful as molded articles, as coating compositions including abrasion resistant coatings, as adhesives including structural adhesives, and as binders for abrasives and magnetic media. The invention also relates to compositions of matter comprising an organometallic complex salt and at least one accelerator component selected from the Class 1 and Class 2 compounds and a peroxyketal disclosed herein.

### BACKGROUND

Transition metal salts comprising an organometallic cation and a non-nucleophilic counteranion have been shown to have utility as photochemically activated initiators for cationic addition polymerization. A number of these cationic organometallic salts can be photochemically activated to initiate cationic polymerization. These photoinitiator salts include (cyclopentadienyl) (arene) iron+salts of the anions PF₆₋ and SbF₆₋. Similarly, certain classes of these salts are known to be thermally-activatable curatives for cationic polymerizations.

For many commercial applications, the monomers being polymerized are often multifunctional (i.e., contain more than one polymerizable group per molecule), for example, epoxides, such as diglycidyl ethers of bisphenol A (DGEBA). Mixtures of multifunctional monomers such as epoxides and polyalcohols (polyols) or polyepoxides and polyalcohols can undergo acid-catalyzed polycondensation via a step-growth mechanism. Also included in this description are multireactive monomers—those that comprise two or more classes of reactive groups.

In many applications photoinduced polymerization is impossible, impractical or undesirable. For example, many situations where polymerization reactions occur in a closed environment (i.e., in a mold or in a laminated product) or where polymerizable compositions may contain opacifying pigments, thermally activated initiators are preferred. Thermally-activated initiators, such as known organometallic salts, may be used to initiate polymerization in these cases.

Another approach to addressing reactions in a closed environment is to photoactivate the reactive polymerizable composition, where very little or no polymerization occurs during the light irradiation step. This photoactivation allows for additional processing steps (e.g. closing an adhesive bond) before the polymerization advances. The polymerization or cure of the composition can proceed at room temperature or with addition of thermal energy.

There is a continuing need to be able to modify the rate and temperature of polymerization of energy polymerizable compositions to meet the needs of specific applications.

### SUMMARY

The present invention relates to accelerators that may be used to influence the temperature at which the polymerization of an energy polymerizable composition comprising a cationically curable material occurs. In particular, the catalyst systems of this invention may be used to reduce the polymerization temperature or allow modification of the rate or degree of polymerization at a given temperature of cationically-polymerizable materials when organometallic salt initiators are used in cationic polymerization.

This disclosure demonstrates the unexpected synergy when hydroxyaromatics and/or beta-diketone complexes are combined with peroxyketals to give an accelerator component that lowers the activation temperature, lowers the onset temperature, and/or provides a faster rate of cure for a cationic polymerization that is initiated by a catalyst system comprising a cationic organometallic salt initiator and the accelerator component.

In one aspect, this invention provides a method comprising the step of using a catalyst system to increase the rate, or reduce the temperature, of cure of an energy polymerizable composition comprising a cationically curable material, a cationic initiator, an accelerator component comprising at least one compound selected from classes 1 and 2 and a peroxy ketal compound.

In another aspect this invention provides a cationic polymerizable composition comprising: (a) at least one cationically curable material; (b) an initiator system comprising: (1) at least one salt of an organometallic complex cation, and (2) an accelerator compound, of classes 1 and 2 wherein class 1 comprises compounds represented by Formula I herein and class 2 comprises compounds represented by Formula II herein, and a peroxy ketal.

In other aspects, the invention provides an cationically polymerizable composition with one or more of the following optional components: (a) at least one of an alcohol-containing material (e.g. a polyol such as a diol, triol, tetraol, etc.) and additional adjuvants; (b) stabilizing ligands to improve shelf-life; (c) at least one film-forming thermoplastic oligomeric or polymeric resin essentially free of nucleophilic groups, such as amine, amide, nitrile, sulfur, or phosphorous functional groups or metal-complexing groups, such as carboxylic acid and sulfonic acid; and (d) coupling agents to modify adhesion.

In other aspects, the invention provides an cationically polymerizable composition with one or more of the following optional components: (a) at least one of an alcohol-containing material and additional adjuvants; (b) stabilizing ligands to improve shelf-life; (c) at least one film-forming thermoplastic oligomeric or polymeric resin essentially free of nucleophilic groups, such as amine, amide, nitrile, sulfur, or phosphorous functional groups or metal-complexing groups, such as carboxylic acid and sulfonic acid; and (d) coupling agents to modify adhesion.

In another aspect, the invention provides a process for controlling or modifying the cure of a composition comprising the steps of: (a) providing the cationically polymerizable composition of the invention, (b) adding sufficient energy to the composition in the form of at least one of heat, radiation, and light, in any combination and order, to polymerize the composition.

In another aspect, this invention provides an article comprising a substrate having on at least one surface thereof a layer of the composition of the invention. The article can be provided by a method comprising the steps: (a) providing a substrate, (b) coating the substrate with the curable composition of the invention and, optionally, adjuvants; and (c) supplying sufficient energy to the composition in the form of at least one of heat, radiation, and light in any combination and order to polymerize the composition.

In another aspect, this invention provides a composition of matter comprising (1) at least one salt of an organometallic complex cation and (2) at least one compound, or an active portion thereof, from classes 1 and 2 wherein class 1 comprises compounds represented by Formula III herein and class 2 comprises compounds represented by Formula IV herein.

As used in this application: “energy-induced curing” means curing or polymerization by means of heat, light (e.g., ultraviolet, visible) or radiation, (e.g., electron beam), or light in combination with heat means, such that heat and light are used simultaneously, or in any sequence, for example, heat followed by light, light followed by heat followed by light;

“catalytically-effective amount” means a quantity sufficient to effect polymerization of the curable composition to a polymerized product at least to a degree to cause an increase in viscosity of the composition under the conditions specified;

“organometallic salt” means an ionic salt of an organometallic complex cation, wherein the cation contains at least one carbon atom of an organic group that is bonded to a metal atom of the transition metal series of the Periodic Table of Elements (“Basic Inorganic Chemistry”, F. A. Cotton, G. Wilkinson, Wiley, 1976, p. 497); “initiator” and “catalyst” are used interchangeably and mean at least one salt of an organometallic complex cation that can change the speed of a chemical reaction;

“cationically curable monomer” means at least one epoxide-containing vinyl ether-containing or oxetane-containing material; “polymerizable composition” or “curable composition” as used herein means a mixture of the initiator system and the cationically curable monomer; alcohols and adjuvants optionally can be present;

“initiation system”, “initiator system”, or “two-component initiator” means at least one salt of an organometallic complex cation and at least one accelerator, the system being capable of initiating polymerization;

“accelerator” or “accelerator compound” or “accelerating additive” means at least one of specified classes of compounds that moderate the cure of a composition of the invention by reducing the polymerization temperature or allowing an increase of the rate or degree of polymerization at a given temperature;

“accelerator component” means an accelerator and a peroxyketal

“epoxy-containing” means a material comprising at least one epoxy and may further comprise accelerating additives, stabilizing additives, fillers, diols, and other additives;

An advantage of at least one embodiment of the present invention is that the initiator system can initiate curing of a thermally- or photo-polymerizable composition at temperatures lower than temperatures required for reactions initiated without the accelerator components of the present invention.

Another advantage of at least one embodiment of the invention is that the initiator system can provide enhanced curing of a thermally- or photo-polymerizable composition at a given temperature. For example, at a given temperature, curing time can be reduced as compared to curing times for reactions initiated without the accelerators of the invention.

Yet another advantage of at least one embodiment of the invention is the ability to affect a color change in the curable composition upon activation of a catalyst in the composition or as the composition changes from an uncured to a cured state.

### BRIEF DESCRIPTION OF THE FIGURES

FIG. 1 illustrates the DSC data of Example C12, Example C1, Example C2, and Example 3.

FIG. 2 illustrates the same exotherm traces with the y-axis magnified.

FIG. 3 illustrates the running integral of the DSC traces of the exotherms in FIG. 1.

### DETAILED DESCRIPTION

In some embodiments the cationic initiator may be a thermal cationic initiator or a cationic photoinitiator.

In some embodiments, a sensitizer may be used as a dye or an indicator which undergoes a color change which reflects the onset of curing. The incipient acid released from the initiator reacts with the sensitizer, effecting a color change.

A class of cationic initiators suitable for use in the present invention comprises photoactivatable organometallic complex salts such as those described in U.S. Pat. Nos. 5,059,701; 5,191,101; and 5,252,694. Such salts of organometallic cations have the general formula:

[(L¹)(L²)M^{m}]^{+e}X⁻

wherein
M^{m} represents a metal atom selected from elements of periodic groups IVB, VB, VIB, VIIB, and VIII, desirably Cr, Mo, W, Mn, Re, Fe, and Co;
L¹ represents none, one, or two ligands contributing π-electrons, wherein the ligands may be the same or different, and each ligand may be selected from the group consisting of substituted and unsubstituted alicyclic and cyclic unsaturated compounds and substituted and unsubstituted carbocyclic aromatic and heterocyclic aromatic compounds, each capable of contributing two to twelve π electrons to the valence shell of the metal atom M.

Desirably, L¹ is selected from the group consisting of substituted and unsubstituted η³-allyl, η5-cyclopentadienyl, η7-cycloheptatrienyl compounds, and η6-aromatic compounds selected from the group consisting of η6-benzene and substituted η6-benzene compounds (for example, xylenes) and compounds having 2 to 4 fused rings, each capable of contributing 3 to 8 π electrons to the valence shell of M^{m};

L² represents none or 1 to 3 ligands contributing an even number of sigma-electrons, wherein the ligands may be the same or different, and each ligand may be selected from the group consisting of carbon monoxide, nitrosonium, triphenyl phosphine, triphenyl stibine and derivatives of phosphorous, arsenic and antimony, with the proviso that the total electronic charge contributed to M^{m} by L¹ and L² results in a net residual positive charge of e to the complex; e is an integer having a value of 1 or 2, the residual charge of the complex cation; and

X is a halogen-containing complex anion, as described above such as BF₄⁻, PF₆⁻, AsF₆⁻, SbF₆⁻, FeCl₄⁻, SnCl₅⁻, SbF₅OH⁻, AlCl₄⁻, AlF₆⁻, GaCl₄⁻, InF₄⁻, TiF₆⁻, ZrF₆⁻, B(C₆F₅)₄⁻, B(C₆F₃(CF₃)₂)₄⁻, PF₃(C₂F₅)₃, and ⁻Al(OC(CF₃)₃)₄.

Suitable commercially available cationic initiators include, but are not limited to, (η⁶-cumene) (η⁵-cyclopentadienyl) iron(II) hexafluorophosphate (available as IRGACURE™ 261 from BASF Corporation, Florham Park, N.J.), (η⁶-cumene) (η⁵-cyclopentadienyl) iron(II) hexafluoroantimonate available as R-GEN 262 from Chitec Technology Co. Ltd., Taipei City, Taiwan.

The curable composition comprises one or more cationic photoinitiators in an amount, which varies depending on the light source and the degree of exposure. The curable composition comprises one or more cationic photoinitiators in an amount of 0.1 to 5 parts by weight, based on 100 parts total weight of the curable composition, preferably an amount of 0.1 to 2 parts by weight, based on 100 parts total weight of the curable composition.

Accelerator compounds of the accelerator component may be selected from two classes of materials. The active portions of these materials (see Formulae I, Ia and II) can be part of a polymer or included as part of any component in the compositions of the invention.

Class 1 is described by the Formula I

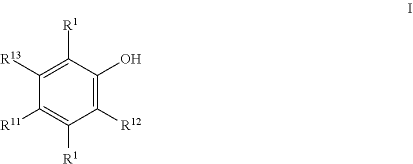

Molecules of Class 1 comprise mono-, di- or polyhydroxy aromatics wherein each R¹, independently, can be hydrogen or a group selected from chloro, iodo, bromo, fluoro, cyano, nitro, nitroso, carboxyl, ester, formyl, acetyl, benzoyl, trialkylsilyl, and trialkoxysilyl. Additionally, each R¹, independently, can be a radical moiety selected from substituted and unsubstituted alkyl, alkenyl, alkynyl, and alkoxy groups containing up to 30 carbon atoms, or groups of one to four substituted or unsubstituted aromatic rings wherein two to four rings can be fused or unfused, or two R¹ s taken together can form at least one ring which is saturated or unsaturated and the ring can be substituted or unsubstituted. Each R¹, independently, can also be a hydroxy such that the ring will have more than two hydroxy aromatic groups. R¹¹, R¹² and R¹³ are independently hydroxy, or a carbonyl-containing functional groups including carboxyl, ester, formyl, benzoyl or acetyl It is preferred that no more than two of proviso that R¹¹, R¹² and R¹³ are a carbonyl-containing functional group. In some preferred embodiments, R¹² and R¹³ are carbonyl-containing functional groups.

When the molecule contains more than two aromatic hydroxy groups, at least two of the hydroxy groups are desirably adjacent to each other, i.e., in an ortho position. It is important that the substituting groups not interfere with the complexing action of the accelerating additive with the metal complex, or interfere with the cationic polymerization.

In some preferred embodiments, R¹² is hydroxy and R¹¹ is a carbonyl-containing functional group including carboxyl, ester, formyl, benzoyl or acetyl and it is para to a hydroxy group. Such compounds may be represented by the Formula Ia:

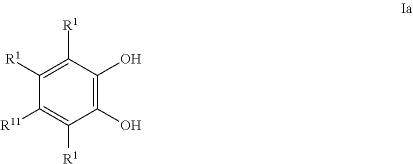

where R1 is as previously described and R11 is a carbonyl-containing functional groups include carboxy, ester, ketone and aldehyde.

Examples of R¹ groups, include hydrocarbyl groups such as methyl, ethyl, butyl, dodecyl, tetracosanyl, phenyl, benzyl, allyl, benzylidene, ethenyl, and ethynyl; cyclohydrocarbyl groups such as cyclohexyl; hydrocarbyloxy groups such as methoxy, butoxy, and phenoxy; hydrocarbylmercapto groups such as methylmercapto (thiomethoxy), phenylmercapto (thiophenoxy); hydrocarbyloxycarbonyl such as methoxycarbonyl, propoxycarbonyl, and phenoxycarbonyl; hydrocarbylcarbonyl such as formyl, acetyl, and benzoyl; hydrocarbylcarbonyloxy such as acetoxy, and cyclohexanecarbonyloxy; perfluorohydrocarbyl groups such as trifluoromethyl and pentafluorophenyl; azo; boryl; halo, for example, chloro, iodo, bromo, and fluoro; hydroxy; cyano; nitro; nitroso; trimethylsiloxy; and aromatic groups such as cyclopentadienyl, phenyl, naphthyl and indenyl. Additionally, the R¹ may be a unit of a polymer. Examples of this type would be catechol novolak resins, or polystyrene type polymers where the phenyl ring is substituted with at least ortho-dihydroxy groups.

Examples of suitable Class I accelerators are catechol; pyrogallol; gallic acid; esters of gallic acid (prepared from the condensation of the carboxylic acid of gallic acid with alcohols), such as, methyl gallate, ethyl gallate, propyl gallate, butyl gallate; tannins such as tannic acid; alkylcatechols such as 4-tert-butylcatechol, nitrocatechols such as 4-nitrocatechol, methoxycatechol such as 3-methoxycatechol; 2,3,4-trihydroxybenzophenone; 2,3,4-trihydroxyacetophenone; salicylaldehyde, and methyl salicylate.

Class 1 accelerators can be present in an amount in the range of 0.01 to 10.0 weight percent, preferably 0.1 to 4 weight percent of the total polymerizable composition.

Class 2 is described by the Formula III:

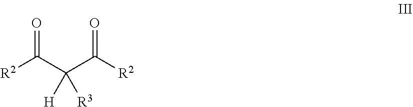

Molecules of Class 2 comprise those compounds having β-diketone moiety wherein each R² can be the same or different and, excluding hydrogen, can be the same as R¹ described for the Class 1 accelerators, and wherein R³ can be a substituted or unsubstituted alkyl or aryl group. Examples of suitable accelerators of this class are 2,4-pentanedione, 3,5-heptanedione, 1,3-diphenyl-1,3-propanedione, 1-phenyl-1,3-butanedione, 1,1,1-trifluoro-2,4-pentanedione, 1,1,1,5,5,5-hexafluoro-2,4-pentanedione, and 1-(4-methoxyphenyl)-3-(4-tert-butylphenyl)propane-1,3-dione available as PARSOL 1789 from Roche Vitamins, Inc., Parsippany, N.J., and as EUSOLEX 9020 from EM Industries, Inc., Hawthorne, N.Y. The preferred compound from Class 2 is 2,4-pentanedione.

Class 2 accelerators can be present in an amount in the range of 0.05 to 10.0 weight percent, preferably 0.05 to 4 weight percent of the total polymerizable composition.

It should be noted that accelerators of different classes, or even within a class, may not be equally effective with any given initiator.

In addition to the accelerator compound of classes I and II, the accelerator component further comprises a peroxy ketal, of the general formula: R⁵R⁶C(O—O—R⁷)₂, where R⁵ and R⁶ are each alkyl, or may be taken together to form ring, and each R⁷ is an alkyl group.

Suitable peroxyketals may include 1,1-bis(t-butylperoxy)-3,3,5-trimethylcyclohexane, 1,1-bis(t-butylperoxy)cyclohexane, 1,1-bis(t-amylperoxy)-cyclohexane, 2,2-bis(t-butylperoxy)butane, 2,2-bis(t-butylperoxy)octane, ethyl 3,3-bis(t-amylperoxy) butyrate, and 4,4-bis(t-butylperoxy)valeric acid-n-butylester. Peroxyketals may be prepared as described in EP 1100776 (Frenkel et al.) and U.S. Pat. No. 6,362,361 (Nwoko et al)

The peroxyketal is used in amounts 0.1 to 5.0 wt. % of the polymerizable composition, which includes the epoxy, optional (meth)acrylate and optional diluents.

The present invention provides an energy polymerizable composition comprising at least one cationically-polymerizable material and an initiation system therefor, the initiation system comprising at least one organometallic complex salt and at least one accelerator component. The cured composition provides useful articles or coated articles.

Monomers that can be cured or polymerized by the processes of this invention are those known to undergo cationic polymerization and include 1,2-, 1,3-, and 1,4-cyclic ethers (also designated as 1,2-, 1,3-, and 1,4-epoxides). See the “Encyclopedia of Polymer Science and Technology”, 6, (1986), p. 322, for a description of suitable epoxy resins.

The epoxy resins or epoxides that are useful in the composition of the present disclosure may be any organic compound having at least one oxirane ring that is polymerizable by ring opening, i.e., an average epoxy functionality greater than one, and preferably at least two. The epoxides can be monomeric or polymeric, and aliphatic, cycloaliphatic, heterocyclic, aromatic, hydrogenated, or mixtures thereof. Preferred epoxides contain more than 1.5 epoxy group per molecule and preferably at least 2 epoxy groups per molecule. The useful materials typically have a weight average molecular weight of about 150 to about 10,000, and more typically of about 180 to about 1,000. The molecular weight of the epoxy resin is usually selected to provide the desired properties of the cured adhesive. Suitable epoxy resins include linear polymeric epoxides having terminal epoxy groups (e.g., a diglycidyl ether of a polyoxyalkylene glycol), polymeric epoxides having skeletal epoxy groups (e.g., polybutadiene poly epoxy), and polymeric epoxides having pendant epoxy groups (e.g., a glycidyl methacrylate polymer or copolymer), and mixtures thereof. The epoxide-containing materials include compounds having the general formula:

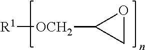

where R1 is an alkyl, alkyl ether, or aryl, and n is 1 to 6.

These epoxy resins include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1, 1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Also useful are polyhydric phenolic formaldehyde condensation products as well as polyglycidyl ethers that contain as reactive groups only epoxy groups or hydroxy groups. Useful curable epoxy resins are also described in various publications including, for example, “Handbook of Epoxy Resins” by Lee and Nevill, McGraw-Hill Book Co., New York (1967), and Encyclopedia of Polymer Science and Technology, 6, p. 322 (1986).

The choice of the epoxy resin used depends upon the end use for which it is intended. Epoxides with flexibilized backbones may be desired where a greater amount of ductility is needed in the bond line. Materials such as diglycidyl ethers of bisphenol A and diglycidyl ethers of bisphenol F can provide desirable structural adhesive properties that these materials attain upon curing, while hydrogenated versions of these epoxies may be useful for compatibility with substrates having oily surfaces.

Examples of commercially available epoxides useful in the present disclosure include diglycidyl ethers of bisphenol A (e.g, those available under the trade designations EPON 828, EPON 1001, EPON 1004, EPON 2004, from Hexion Inc., Columbus, Ohio, and those under the trade designations D.E.R. 331, D.E.R. 332, D.E.R. 334, and D.E.N. 439 available from Olin Corporation, Clayton Mo.); hydrogenated diglycidyl ether of bisphenol A (e.g. EPONEX 1510 from Hexion Inc., Columbus, Ohio); diglycidyl ethers of bisphenol F (e.g., that are available under the trade designation ARALDITE GY 281 available from Huntsman Corporation); cycloaliphatic epoxies under the trade designation CELLOXIDE from Daicel USA Inc., Fort Lee, N.J., and those under the trade designation SYNA from Synasia Inc. Metuchen, N.J., such as vinylcyclohexene oxide, vinylcyclohexene dioxide, 3,4-epoxycyclohexylmethyl-3,4-epoxycyclohexane carboxylate, bis-(3,4-epoxycyclohexyl) adipate and 2-(3,4-epoxycylclohexyl-5,5-spiro-3,4-epoxy) cyclohexene-meta-dioxane, silicone resins containing diglycidyl epoxy or epoxycyclohexyl functionality such as 1,3-bis[2-(3,4-epoxycyclohexyl)ethyl]tetramethyldisiloxane and epoxypropoxypropyl terminated polyphenylmethylsiloxane (both available from Gelest Inc. Morrisville Pa.); flame retardant epoxy resins (e.g., that are available under the trade designation DER 560, a brominated bisphenol type epoxy resin available from Olin Corporation); epoxidized vegetable oils such as epoxidized linseed and soybean oils available as VIKOLOX and VIKOFLEX resins from Arkema Inc., King of Prussia, Pa., epoxidized KRATON LIQUID Polymers, such as L-207 available from Kuraray Co. Ltd., Tokyo, Japan, epoxidized polybutadienes such as the POLY BD resins from Total Cray Valley, Exton, Pa., polyglycidyl ether of phenolformaldehyde, epoxidized phenolic novolac resins such as DEN 431 and DEN 438 available from Olin corporation, epoxidized cresol novolac resins such as ARALDITE ECN 1299 available from Huntsman Advanced Materials, The Woodlands, Tex., resorcinol diglycidyl ether, and epoxidized polystyrene/polybutadiene blends such as the EPOFRIEND resins such as EPOFRIEND A1010 available from Daicel USA Inc., Fort Lee, N.J., HELOXY 67 (diglycidyl ether of 1,4-butanediol) HELOXY 107 (diglycidyl ether of cyclohexane dimethanol) or their equivalent from other manufacturers, and resorcinol diglycidyl ether.

Epoxy containing compounds having at least one glycidyl ether terminal portion, and preferably, a saturated or unsaturated cyclic backbone may optionally be added to the composition as reactive diluents. Reactive diluents may be added for various purposes such as to aid in processing, e.g., to control the viscosity in the composition as well as during curing, to flexibilize the cured composition, and to compatibilize materials in the composition.

Examples of such diluents include: diglycidyl ether of cyclohexanedimethanol, diglycidyl ether of resorcinol, p-tert-butyl phenyl glycidyl ether, cresyl glycidyl ether, diglycidyl ether of neopentyl glycol, triglycidyl ether of trimethylolethane, triglycidyl ether of trimethylolpropane, and vegetable oil polyglycidyl ether. Reactive diluents are commercially available under the trade designation HELOXY 107 and CARDURA N10 from Momentive Specialty Chemicals, Inc. The composition may contain a toughening agent to aid in providing the desired overlap shear, peel resistance, and impact strength.

The curable composition desirably contains one or more epoxy resins having an epoxy equivalent weight of from about 100 to about 1500. More desirably, the adhesive contains one or more epoxy resins having an epoxy equivalent weight of from about 300 to about 1200. Even more desirably, the adhesive contains two or more epoxy resins, wherein at least one epoxy resin has an epoxy equivalent weight of from about 300 to about 500, and at least one epoxy resin has an epoxy equivalent weight of from about 1000 to about 1200.

The curable composition may comprise one or more epoxy resins in an amount, which varies depending on the desired properties of the structural adhesive layer. Desirably, the adhesive composition comprises one or more epoxy resins in an amount of from 25 to 50 parts, preferably 35-45 parts by weight, based on the 100 parts total weight of the monomers/copolymers in the adhesive composition.

The preferred epoxy resins include the CELLOXIDE and SYNA type of resins especially 3,4-epoxycyclohexylmethyl-3,4-epoxycyclohexanecarboxylate, bis-(3,4-epoxycyclohexyl) adipate and 2-(3,4-epoxycylclohexyl-5,5-spiro-3,4-epoxy) cyclohexene-meta-dioxane and the bisphenol A EPON type resins including 2,2-bis-[p-(2,3-epoxypropoxy)phenylpropane and chain extended versions of this material. It is also within the scope of this invention to use a blend of more than one epoxy resin.

Alternatively, one may use vinyl ether monomers as the cationically curable material. Vinyl ether-containing monomers can be methyl vinyl ether, ethyl vinyl ether, tert-butyl vinyl ether, isobutyl vinyl ether, cyclohexyl vinyl ether, 2-ethylhexyl vinyl ether, diethyleneglycol divinyl ether, trimethylolpropane trivinyl ether, triethyleneglycol divinyl ether, 1,4-cyclohexanedimethanol divinyl ether, trimethylolpropane trivinyl ether (all available from BASF Corp., Florham Park, N.J.) and the VECTOMER divinyl ether resins from Allied Signal, such as VECTOMER 2010, VECTOMER 2020, VECTOMER 4010, and VECTOMER 4020, or their equivalent from other manufacturers. It is within the scope of this invention to use a blend of more than one vinyl ether resin.

Additionally, oxetane resins are another optional cationically curable resin suitable for certain embodiments of the curable resin system. Oxetane (i.e., 1,3-propylene oxide) is a cyclic ether. Substituted oxetanes may also be suitable for use in the curable resin system. Suitable oxetane materials include those manufactured by Toagosei Co., LTD Tokyo, Japan) under the trade designation ARON OXETANE, such as 3-ethyl-3-hydroxymethyloxetane (OXT-101), 1,4-bis [(3-ethyl-3-oxetanylmethoxy)methyl]benzene (OXT-121), 3-ethyl-3-[(2-ethylhexyloxy)methyl]oxetane (OXT-212), bis-[1-ethyl(3-oxetanyl)]methyl ether (OXT-221). It is within the scope of this invention to use a blend of more than one vinyl ether resin.

The curable composition optionally comprises a free radically polymerizable (meth)acrylate monomer to provide the initial adhesion of the materials to be bonded (for example, electronic devices) and/or increase the viscosity by initial polymerization of the (meth)acylates.

To ensure that the acrylate monomer is compatible well with other components contained in the composition, it is required to make selection as to the compatibility of the acrylate monomer. In the present invention, the solubility parameter of the acrylate monomer is between 9.3 and 13.5 (cal/cm³)^{0.5} (see, Journal of Applied Polymer Science, vol. 116, pages 1-9 (2010)). Examples of acrylate monomer useful in the present invention include one or more substance selected from the group consisting of tert-butyl acrylate (tBA, solubility parameter: 9.36), phenoxy ethyl acrylate (PEA, solubility parameter: 10.9), isobornyl acrylate (IBoA, solubility parameter: 9.71), Propenoic acid, 2-hydroxy-3-phenoxypropyl ester (HPPA, solubility parameter: 12.94), N-vinypyrrolidone (NVP, solubility parameter: 13.38), and n-vinyl-epsilon-caprolactam (NVC, solubility parameter: 12.1), and the like.

For stability of the polymerizable composition, the (meth)acrylate monomer component contains essentially no acid functional monomers, whose presence would initiate polymerization of the epoxy resin prior to UV curing. For the same reason, it is preferred that the (meth)acrylate monomer component not contain any amine-functional monomers. Furthermore, it is preferred that the (meth)acrylate monomer component not contain any acrylic monomers having moieties sufficiently basic so as to inhibit cationic cure of the composition.

The amount of the acrylate monomer as described above present in the acrylate/epoxy resin hybrid composition is typically between 1 wt. % and 50 wt. %, more preferably between 1 wt. % and 20 wt. % of the polymerizable components. As such, the acrylate monomer can be compatible well with the epoxy resin and bring very good toughening effect to the cured epoxy resin.

The amount of the epoxy resins as described above present in the acrylate/epoxy resin hybrid system composition of the present invention is typically between 50 wt. % and 99 wt. %, more preferably between 80 wt. % and 99 wt. %. As such, a sufficient strength of the curable composition (e.g. structural adhesive) can be ensured after cure.

A free radical thermal- or photo-initiator is used in the hybrid composition to polymerize the acrylate monomers under irradiation of light (for example, UV light) to provide an initial adhesion and/or increase the viscosity for coating. A free radical photoinitiator is a compound which a photochemical reaction may occur to generate free radicals upon being irradiated by light. The free radicals generated by the free radical photoinitiator can initiate free radical polymerization of the system which would result in cure of the same. Photoinitiators of different structures may have different absorption spectrum and free radical activity. Examples of free radical photoinitiators include: acetophenones such as 2,2-dimethoxy-2-phenylacetophenone (BDK), 1-hydroxycyclohexyl phenyl ketone (184), 2-hydroxy-2-methyl-phenyl-propane-1-one (1173), thioxanthones such as 2-isopropyl thioxanthone or 4-isopropyl thioxanthone (ITX), acryl phosphine oxides such as 2,4,6-trimethylbenzoyldiphenyl phosphine oxide (TPO) and 2,4,6-trimethylbenzoyldiphenyl phosphine oxide (819), and the like.

The amount of the free radical photoinitiators as described above present in the acrylate/epoxy resin hybrid system based structural adhesive tape composition of the present invention is typically between 0.001 wt. % and 3.0 wt. %, more preferably between 0.25 wt. % and 2.2 wt. %. If the amount of the free radical photoinitiators is too low, the curing speed of the low temperature cure pressure-sensitive structural glue may be too slow upon UV light irradiation and thus the coating speed may be slow. If the amount of the free radical photoinitiators is too high, the curing speed of the low temperature cure pressure-sensitive structural glue may be too quick upon UV light irradiation and thus the molecular weight of the resulting acrylate copolymer may be too low, which may not be able to toughen the epoxy resins effectively.

In such embodiments the curable composition may comprise:

1-50 wt. % of a (meth)acrylate monomer;
50-99 wt. % of an epoxy resin;
0.001-3 wt. % of a free radical photoinitiator;
0.02-5 wt. % of a cationic initiator, based upon the total weight of the curable

The cured, partially cured or uncured adhesive composition may be coated on a substrate to form an adhesive article. For example, the substrate can be flexible or inflexible and can be formed from a polymeric material, glass or ceramic material, metal, or combination thereof. Some substrates are polymeric films such as those prepared from polyolefins (e.g., polyethylene, polypropylene, or copolymers thereof), polyurethanes, polyvinyl acetates, polyvinyl chlorides, polyesters (polyethylene terephthalate or polyethylene naphthalate), polycarbonates, polymethyl(meth)acrylates (PMMA), ethylene-vinyl acetate copolymers, and cellulosic materials (e.g., cellulose acetate, cellulose triacetate, and ethyl cellulose).

Other substrates are metal foils, nonwoven materials (e.g., paper, cloth, nonwoven scrims), foams (e.g., polyacrylic, polyethylene, polyurethane, neoprene), and the like. For some substrates, it may be desirable to treat the surface to improve adhesion to the crosslinked composition, crosslinked composition, or both. Such treatments include, for example, application of primer layers, surface modification layer (e.g., corona treatment or surface abrasion), or both.

In some embodiments the adhesive article comprises a nonwoven scrim embedded in the adhesive layer.

In some embodiments, the substrate is a release liner to form an adhesive article of the construction substrate/adhesive layer/release liner. The adhesive layer may be cured, uncured or partially cured. Release liners typically have low affinity for the curable composition. Exemplary release liners can be prepared from paper (e.g., Kraft paper) or other types of polymeric material. Some release liners are coated with an outer layer of a release agent such as a silicone-containing material or a fluorocarbon-containing material.

The present disclosure further provides a method of bonding comprising the steps of providing a substrate (or workpiece) having a layer of the curable composition on a surface thereof, exposing the adhesive layer to actinic radiation (such as UV) to initiate curing, and affixing the first substrate to a second substrate (or workpiece), and optionally heating the bonded workpieces.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements.

Unless otherwise noted, all parts, percentages, ratios, etc., in the Examples and the rest of the specification are by weight. In the Examples, ° C.=degrees Celsius, g=grams, min=minute, mm=millimeter, nm=nanometers, and rpm=revolutions per minute.

### Differential Photo-Calorimetry (PDSC)

Differential Photo-Calorimetry was used to measure the exothermic heat of reaction associated with the photoinitiated cure of a cationically polymerizable monomer during exposure to light. PDSC samples sizes were typically 4 to 8 milligrams (mg). Testing was done in open, aluminum low-mass pans (Tzero brand from TA Instruments Inc., New Castle, Del.), under nitrogen purge, in a TA Instruments Inc. Q200DSC base, equipped with a differential photocalorimeter accessory (Part number 935000.901 from TA Instruments Inc., New Castle, Del.). A 200 watt (W) high-pressure mercury lamp was filtered to delivers light over the spectral range of 320 to 500 nanometers (nm), and was set to an aperture setting of 20 on the unit. Unless otherwise stated, all PDSC experiments of this disclosure were performed isothermally at 30° C. throughout the entire PDSC experiment. The sample is kept dark for 1 minute, then a shutter is opened to allow the sample to be irradiated for 3 minutes, after which the shutter is closed, and the sample is kept dark for an additional 1 minute.

The data from the PDSC experiment was analyzed using TA Instruments Inc. Universal Analysis software, with the data graphed showing heat flow versus time. If an exothermic peak was present, the area under the exothermic peak represents the total exotherm energy produced during the irradiation and is measured in Joules/gram (J/g). The exotherm energy is proportional to the extent of cure, and for any particular reaction an increase in the total DPC exotherm energy would indicate a higher degree of cure during the irradiation. Immediately following the DPC experiment, the samples were transferred to another Q200 differential scanning calorimeter (DSC) equipped with a refrigerated cooling unit (RCS90 from TA Instruments Inc., New Castle, Del.) and heated at 10° C./minute in a DSC experiment as described below. The Total Exotherm Energy is the combination of PDSC and DSC Energies and is the total exotherm energy of polymerization.

Differential Scanning Calorimetry (DSC) was performed on a TA Instruments Inc. (New Castle, Del.) Q200DSC, and used to measure the exothermic heat of reaction associated with the thermal cure of the cationically polymerizable resin composition. DSC samples were typically 4 to 8 mg. Testing was done in open, aluminum low-mass pans (Tzero brand from TA Instruments Inc., New Castle, Del.), at a heating rate of 10° C./min from 0° C. to 200° C. The data from the reaction process was analyzed using TA Instruments Inc. Universal Analysis software, with the data graphed showing heat flow versus time and heat flow versus temperature. The integrated area under an exothermic peak represents the total exotherm energy released during the reaction and is measured in Joules/gram (J/g); the exotherm energy is proportional to extent of cure, i.e., degree of polymerization. The exotherm profile, i.e., onset time/temperature (the time/temperature at which reaction will begin to occur), peak temperature, peak time, and end temperature, provides information on conditions needed to cure the material. For any particular reaction, a shift toward lower onset and/or peak time/temperature for the exotherm indicates that the reactant material is polymerizing at the lower temperatures, which would correlate to shorter cure times. The data of the exothermic peak can also be analyzed by using a running integral technique, which displays the cumulative percent contribution of the total exothermic peak at any given region (time/temperature) throughout the peak.

Table 1, below, lists abbreviations for materials used in the Examples.

TABLE 1

| Abbreviation | Name | Location |
|---|---|---|
| L231 | di-tert-butylperoxy-3,3,5- | Millipore-Sigma - St. Louis, |
| | trimethylcyclohexaneperoxide | MO |
| L230 | Lupersol 230 | AtoChem North America - |
| | | Buffalo, NY |
| L270 | tert-Butyl peroxy-3,5,5- | Acres OrganicsGeel - |
| | trimethylhexanoate | Belgium |
| AMOX | Di-tert-amyl oxalate ester | 3M Company, St. Paul |
| Catechol | Catechol | 3M Company, St. Paul |
| Pyrogallol | 1,2,3-trihydroxy benzene | Sigma Chemical Company - |
| | | St. Louis, MO |
| Propyl Gallate | Propyl Gallate | Eastman Fine Chemicals - |
| | | Rochester, NY |
| THBP | 2,3,4-trihydroxybenzophenone | Sigma Chemical Company - |
| | | St. Louis, MO |
| NC | 4-nitrocatechol | Sigma Chemical Company - |
| | | St. Louis, MO |
| TBC | 4-tert-butylcatechol | Alfa Aesar - Ward Hill, MA |
| THAP | 2,3,4-trihydroxyacetophenone | Sigma Chemical Company - |
| | | St. Louis, MO |
| CHP | Cumene hydroperoxide | Alfa Aesar - Ward Hill, MA |
| DiAP | Di-tert-amyl peroxide | Ato Chem North America - |
| | | Buffalo, NY |
| Trigonox T (Trig T) | tert-butyl cumyl peroxide | J&K Scientific Inc. - |
| | | Sunnyvale, CA |
| AcAc | 2,4-pentanedione (acetylacetone) | Alfa Aesar - Ward Hill, MA |
| Avobenzene | Eusolex 9020 | Em Industries Inc. - |
| | | Darmstadt, Germany |
| Salicylic Acid | Salicylic Acid | Alfa Aesar - Ward Hill, MA |
| 3-methyl salicylic acid | 3-Methyl Salicylic Acid | 3M Company, St. Paul |
| 5-methoxy salicylic acid | 5-Methoxy Salicylic Acid | Sigma Chemical Company - |
| | | St. Louis, MO |
| Methyl Salicylate | methyl 2-hydroxybenzoate | Alfa Aesar - Ward Hill, MA |
| Salicylaldehvde | Salicylaldehyde | Alfa Aesar - Ward Hill, MA |
| EPON 828 | Liquid Bisphenol A di-epoxy | Hexion Inc. - Columbus, |
| | resin | Ohio |
| CELLOXIDE 2021P | (3′,4′-epoxycyclohexane) methyl | Daicel USA Corporation - |
| | 3,4-epoxycyclohexylcarboxylate | Fort Lee, New Jersey |
| CHDM | 1,4-cyclohexanedimethanol | Alfa Aesar - Ward Hill, MA |
| COM | Cationic Organometallic - | 3M Company as described |
| | CpFe(xylenes)SbF₆, where Cp = | in U.S. Pat. No. 5,089,536 |
| | η⁵-cyclopentadienyl | |
| (mes)₂Fe²⁺ | (mesitylene)₂Fe(C(SO₂CF₃)₃)₂ | As described in U.S. |
| | | Pat. No. 5,554,664 |
| 1,6-HD | 1,6-hexanediol | Alfa Aesar - Ward Hill, MA |
| MEKP | 2,2′-Peroxydi(butane-2-peroxol) | 3M Company, St. Paul |
| Prop. Carb. | Propylene Carbonate | Alfa Aesar - Ward Hill, MA |

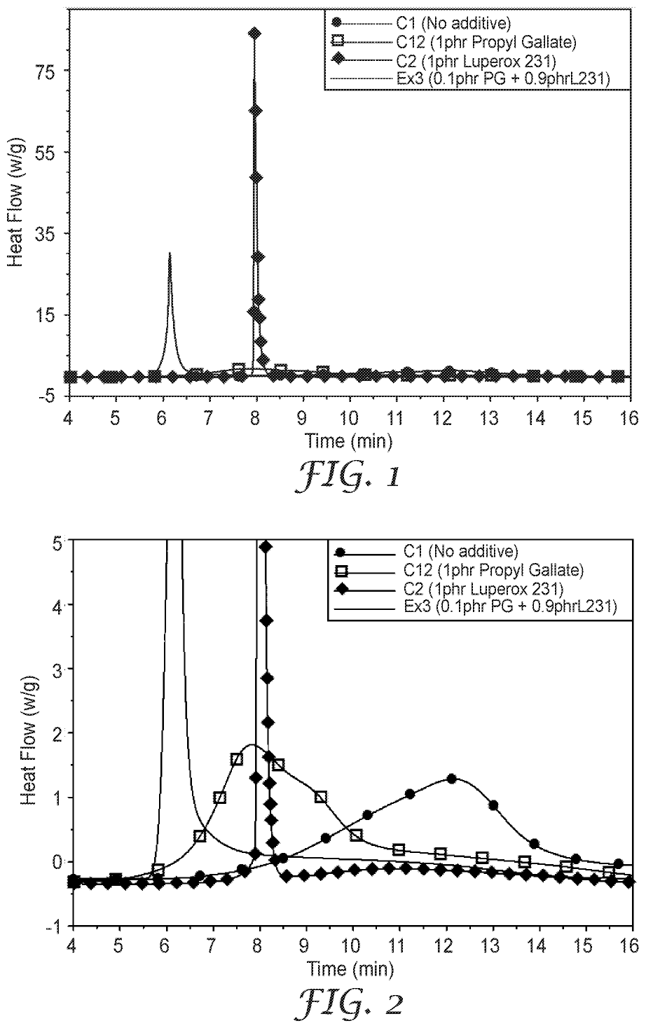

FIG. 1 illustrates the data from a differential scanning calorimeter (DSC) showing the change in onset time, peak time, and end time of the exotherm resulting from the thermal cationic polymerization after light exposure of a composition comprising EPON 828/1,6-hexanediol/1,4-CHDM (95.5:2.25:2.25 parts by weight) initiated with 1 parts per hundred resin (phr) CpFe(xylenes)SbF₆ with no additional additive (Example C12, filled circle), 1 phr propyl gallate (Example C1, open square), 1 phr Luperox 231 (Example C2, filled diamond), and 0.1 phr propyl gallate/0.9 phr Luperox 231 (Example 3, no marker).

FIG. 2 illustrates the same exotherm traces with the y-axis magnified.

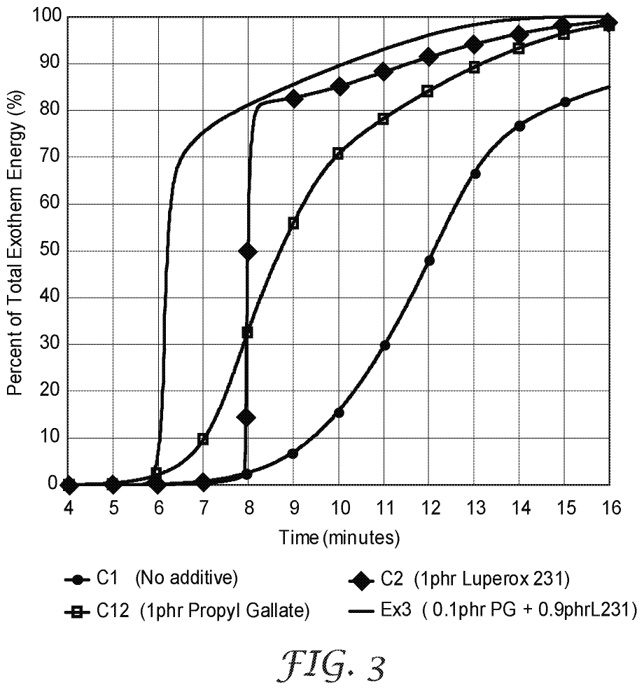

FIG. 3 illustrates the running integral of the DSC traces of the exotherms in FIG. 1, where the percent of the normalized total exotherm energy is displayed versus time.

### Preparatory Example 1: Preparation of Epoxy 1 Stock Solution

EPON 828, CHDM, and 1,6-HD in a ratio of 95.5:2.25:2.25 parts by weight were placed in a black, polypropylene Max300 Long DAC Cup (part number 501 218pb-J from FlackTek, Inc., Landrum, S.C.) for speed mixing. The mixture was then high-shear mixed at ambient temperatures and pressure using a FlakTek, Inc Speed Mixer (DAC 400.2 VAC) in time intervals of 10 seconds at 1000 revolutions per minute (rpm), followed by2 minutes at 2000 rpm, and finishing 10 seconds at 1000 rpm.

### Preparatory Example 2: Preparation of Stock Solutions Containing Epoxy 1 and Additives

To the Epoxy 1 mixture described above, additives were combined in a glass jar and hand stirred with a wooden applicator stick before being placed in a pre-heated 80° C. oven (Despatch LFD1-42-3 Lakeville, Minn.) for 1 hour with occasional hand stirring. After heating, each Epoxy 1-additive stock solution was transferred to a polypropylene DAC Cup to enable high shear mixing on a DAC 150.1 FVZ-K Speedmixer (FlakTek Inc. Landrum S.C.) prior to every use. The high-shear mix conditions were 20 seconds at 1500 rpm. The epoxy/additive stock solutions prepared are shown in Table 2.

TABLE 2
Epoxy/additive stock solution formulations

| | Epoxy | | Additive, |
|---|---|---|---|
| Stock Identity | 1, g | Additive Identity | g |
| Pyrogallol Stock | 20.11 | Pyrogallol | 0.20 |
| Propyl Gallate Stock | 20.04 | Propyl Gallate | 0.20 |
| NC Stock | 20.10 | NC | 0.20 |
| TBC Stock | 40.04 | TBC | 0.40 |
| THAP Stock | 40.05 | THAP | 0.40 |
| Catechol Stock | 100.00 | Catechol | 1.00 |
| THBP Stock | 100.01 | THBP | 1.00 |
| Salicylic Acid Stock | 50.03 | Salicylic Acid | 0.50 |
| 3-Methylsalicylic acid | 50.08 | 3-methyl salicylic | 0.50 |
| Stock | | acid | |
| 5-Methoxysalicylic acid | 50.02 | 5-methoxy salicylic | 0.50 |
| Stock | | acid | |
| Methylsalicylate Stock | 50.06 | Methyl Salicylate | 0.50 |
| Avobenzone Stock | 20.01 | Avobenzone | 0.20 |

### Examples 1-31 and Comparative Examples CA-C33

Each formulation was prepared by using the components shown in Table 3 by combining, under very low room light, COM and propylene carbonate in a white, polypropylene Max10 DAC Cup (501 226m-j FlackTek Inc). The mixture was hand stirred with a wooden applicator stick until no solid COM was visually observed. When Epoxy-1 stock was required in the formulation, the Epoxy-1stock was added and hand mixed for about a minute using a wooden applicator stick. When additives were used in the formulations, Additive 1 was always added before Additive 2, and the mixture was hand stirred for about one minute with a wooden applicator stick after the addition of each additive. The DAC cup was then sealed with a polypropylene screw cap, and high-shear mixed using a Speed Mixer (DAC 150.1 FVZ-K from FlackTek Inc.) for 20 seconds at 2000 rpm to ensure uniform mixing. The polypropylene cups containing the formulations were stored at room temperature in the dark to prevent unwanted light exposure when not being used.

TABLE 3
Example and Comparative Examples formulations

| | | Prop. | | | Additive | | Additive |
|---|---|---|---|---|---|---|---|
| | COM | Carb. | Epoxy-1 | | 1 Mass | | 2 Mass |
| Example | (g) | (g) | (g) | Additive 1 | (g) | Additive 2 | (g) |
| C1 | 0.0586 | 0.0585 | 5.1426 | — | — | — | — |
| C2 | 0.0507 | 0.0722 | 5.0160 | L231 | 0.0498 | — | — |
| C3 | 0.0504 | 0.0916 | 5.0445 | L231 | 0.1054 | — | — |
| C4 | 0.0501 | 0.0704 | 5.0214 | L231 | 0.1534 | — | — |
| C5 | 0.0511 | 0.0757 | 5.0019 | L231 | 0.1973 | — | — |
| C6 | 0.0504 | 0.0745 | 5.0078 | L230 | 0.0494 | — | — |
| C7 | 0.0502 | 0.0731 | 5.0465 | L230 | 0.1003 | — | — |
| C8 | 0.0512 | 0.0758 | 5.0783 | L230 | 0.1556 | — | — |
| C9 | 0.0502 | 0.0707 | 5.0002 | L230 | 0.1995 | — | — |
| C10 | 0.0500 | 0.0785 | — | Catechol Stock | 5.0576 | — | — |
| C11 | 0.0500 | 0.0800 | — | Pyrogallol Stock | 5.0534 | — | — |
| C12 | 0.0502 | 0.0758 | — | Propyl Gallate | 5.0469 | — | — |
| | | | | Stock | | | |
| C13 | 0.0501 | 0.0737 | — | THBP Stock | 5.0262 | — | — |
| C14 | 0.0502 | 0.0764 | — | NC Stock | 5.0114 | — | — |
| C15 | 0.0503 | 0.0806 | — | TBC Stock | 5.0114 | — | — |
| C16 | 0.0503 | 0.0718 | — | THAP Stock | 5.0284 | — | — |
| Example 1 | 0.0501 | 0.0710 | 3.4943 | THBP Stock | 1.5176 | L231 | 0.0453 |
| Example 2 | 0.0501 | 0.0770 | 4.5105 | THBP Stock | 0.5188 | L231 | 0.0469 |
| C17 | 0.0510 | 0.0599 | 5.2930 | L270 | 0.0554 | — | — |
| C18 | 0.0536 | 0.0578 | 5.1945 | CHP | 0.0534 | — | — |
| C19 | 0.0508 | 0.0519 | 5.2271 | DiAP | 0.0514 | — | — |
| C20 | 0.0515 | 0.0536 | 5.0487 | Trigonox T | 0.0596 | — | — |
| Example 3 | 0.0500 | 0.0815 | 4.5265 | Propyl Gallate | 0.5017 | L231 | 0.0448 |
| | | | | Stock | | | |
| Example 4 | 0.0502 | 0.0790 | 4.0298 | Propyl Gallate | 1.0235 | L231 | 0.0463 |
| | | | | Stock | | | |
| Example 5 | 0.0502 | 0.0748 | 3.5416 | Propyl Gallate | 1.5412 | L231 | 0.0453 |
| | | | | Stock | | | |
| Example 6 | 0.0502 | 0.0744 | 4.6193 | Propyl Gallate | 0.5479 | L231 | 0.0358 |
| | | | | Stock | | | |
| Example 7 | 0.0510 | 0.0705 | 2.5844 | Propyl Gallate | 2.5230 | L231 | 0.0448 |
| | | | | Stock | | | |
| Example 8 | 0.0506 | 0.0882 | 4.5146 | Catechol Stock | 0.5262 | L231 | 0.0455 |
| Example 9 | 0.0505 | 0.0736 | 4.5202 | Pyrogallol Stock | 0.5164 | L231 | 0.0451 |
| Example 10 | 0.0501 | 0.0770 | 4.5011 | THBP Stock | 0.5188 | L231 | 0.0469 |
| Example 11 | 0.0501 | 0.0754 | 4.5627 | NC Stock | 0.5086 | L231 | 0.0455 |
| Example 12 | 0.0504 | 0.0702 | 4.5590 | TBC Stock | 0.5370 | L231 | 0.0451 |
| Example 13 | 0.0500 | 0.0703 | 4.5013 | THAP Stock | 0.5633 | L231 | 0.0454 |
| Example 14 | 0.0507 | 0.0703 | 2.5978 | Pyrogallol Stock | 2.6165 | L231 | 0.0450 |
| Example 15 | 0.0503 | 0.0719 | 2.5243 | THBP Stock | 2.5376 | L231 | 0.0451 |
| Example 16 | 0.0520 | 0.0710 | 2.5562 | Catechol Stock | 2.5430 | L231 | 0.0446 |
| Example 17 | 0.0500 | 0.0761 | 5.0491 | AcAc | 0.0049 | L231 | 0.0477 |
| Example 18 | 0.0501 | 0.0747 | 5.0088 | AcAc | 0.0113 | L231 | 0.0453 |
| Example 19 | 0.0501 | 0.0775 | 5.0144 | AcAc | 0.0156 | L231 | 0.0453 |
| Example 20 | 0.0501 | 0.0752 | 5.0015 | AcAc | 1.0246 | L231 | 1.0452 |
| C21 | 0.0508 | 0.0734 | — | Avobenzone | 5.0055 | — | — |
| Example 21 | 0.0529 | 0.0724 | 2.5295 | Avobenzone | 2.5669 | L231 | 0.0463 |
| Example 22 | 0.0526 | 0.0735 | 4.5506 | Avobenzone | 0.5104 | L231 | 0.0463 |
| C22 | 0.0517 | 0.0724 | 5.0193 | AcAc | 0.0591 | — | — |
| Example 23 | 0.0507 | 0.0703 | 2.5978 | Pyrogallol Stock | 2.6165 | L231 | 0.0450 |
| Example 24 | 0.0510 | 0.0705 | 2.5844 | Propyl Gallate | 2.5230 | L231 | 0.0448 |
| | | | | Stock | | | |
| Example 25 | 0.0503 | 0.0719 | 2.5243 | THBP Stock | 2.5376 | L231 | 0.0451 |
| C23 | 0.0520 | 0.0710 | 2.5562 | Catechol Stock | 2.5430 | L231 | 0.0446 |
| C24 | 0.0506 | 0.0701 | — | Methylsalicylate | 5.1187 | — | — |
| | | | | Stock | | | |
| C25 | 0.0501 | 0.0726 | — | Salicylic Acid | 5.0117 | — | — |
| | | | | Stock | | | |
| C26 | 0.0510 | 0.0790 | — | 3- | 5.0249 | — | — |
| | | | | Methylsalicylic | | | |
| | | | | acid Stock | | | |
| C27 | 0.0581 | 0.0703 | — | 5- | 5.0267 | — | — |
| | | | | Methoxysalicylic | | | |
| | | | | acid Stock | | | |
| Example 26 | 0.0500 | 0.0765 | 4.5367 | Methylsalicylate | 0.5280 | L231 | 0.0484 |
| | | | | Stock | | | |
| Example 27 | 0.0499 | 0.0743 | 4.5188 | Salicylic Acid | 0.5708 | L231 | 0.0493 |
| | | | | Stock | | | |
| Example 28 | 0.0501 | 0.0795 | 4.9697 | 5- | 0.5072 | L231 | 0.0459 |
| | | | | Methoxysalicylic | | | |
| | | | | acid Stock | | | |
| Example 29 | 0.0507 | 0.0700 | 5.0515 | 3- | 0.5602 | L231 | 0.0446 |
| | | | | Methylsalicylic | | | |
| | | | | acid Stock | | | |
| C28 | 0.0497 | 0.0740 | 5.0267 | Salicylaldehyde | 0.0505 | — | — |
| Example 30 | 0.0505 | 0.0729 | 4.6020 | Salicylaldehyde | 0.0047 | L231 | 0.0474 |
| Example 31 | 0.0507 | 0.0697 | 4.5935 | Pyrogallol Stock | 0.55389 | L230 | 0.0470 |
| C29 | 0.0510 | 0.0734 | 4.5204 | Pyrogallol Stock | 0.5629 | L270 | 0.0446 |
| C30 | 0.0500 | 0.0734 | 4.5150 | Pyrogallol Stock | 0.6954 | CHP | 0.0450 |
| C31 | 0.0497 | 0.0786 | 4.5168 | Pyrogallol Stock | 0.5347 | DiAP | 0.0477 |
| C32 | 0.0506 | 0.0737 | 4.5304 | Pyrogallol Stock | 0.5928 | TrigT | 0.0448 |
| C33 | 0.0506 | 0.0765 | 4.5486 | Pyrogallol Stock | 0.5188 | MEKP | 0.0441 |

Results:

The formulations of Table 3 were analyzed by PDSC followed by DSC as described in the general experimental above, and the results are shown in Table 4.

TABLE 4
PDSC and DSC data

| | | PDSC | Visual | TA | TA | | Peak Width | |
|---|---|---|---|---|---|---|---|---|
| | | Exotherm | Onset | Onset | Onset | Exotherm | @ Half | Time to |
| | | Energy | Temp | Temp | Time | Energy | Max Height | 70% Cure |
| Example | Sample Info | (J/g) | (min) | (° C.) | (min) | (J/g) | (min) | (min) |
| C2 | 1 phr L231 | N.M. | 7.8 | 78.95 | 7.93 | 475.8 | 0.07 | 8.1 |
| C3 | 2 phr L231 | N.M. | 6.8 | 73.36 | 7.24 | 512.9 | 0.09 | 7.5 |
| C4 | 3 phr L231 | 0.8631 | 6.4 | 66.73 | 6.66 | 522.8 | 0.14 | 7.3 |
| C5 | 4 phr L231 | 0.2362 | 6.5 | 66.64 | 6.69 | 508.8 | 0.04 | 6.8 |
| C6 | 1 phr L230 | N.M. | 7.7 | 79.93 | 7.98 | 469.9 | 0.06 | 8.1 |
| C7 | 2 phr L230 | 1.733 | 6.8 | 70.73 | 7.04 | 467.5 | 0.05 | 7.2 |
| C8 | 3 phr L230 | 4.208 | 6.2 | 65.79 | 6.43 | 489 | 0.06 | 6.6 |
| C9 | 4 phr L230 | 6.534 | 5.6 | 60.88 | 6.03 | 519.2 | 0.11 | 7.1 |
| C10 | 1 phr Catechol | 0.0286 | 5.0 | 74.34 | 7.57 | 476.7 | 3.41 | 11.2 |
| C11 | 1 phr | N.M. | 4.3 | 62.58 | 6.39 | 486 | 2.29 | 9.8 |
| | Pyrogallol | | | | | | | |
| C12 | 1 phr Propyl | N.M. | 3.6 | 62.5 | 6.38 | 463.3 | 2.61 | 9.9 |
| | Gallate | | | | | | | |
| C1 | No Additive | 2.77 | 5.1 | 77.05 | 7.82 | 466.2 | 3.7 | 13.2 |
| C13 | 1 phr THBP | N.M. | 4.2 | 49.46 | 5.08 | 472 | 3.17 | 9.5 |
| C14 | 1 phr 4- | N.M. | 4.1 | 76.15 | 7.73 | 455.3 | 1.33 | 9.6 |
| | nitrocatechol | | | | | | | |
| C15 | 1 phr 4-t- | N.M. | 4.5 | 87.08 | 8.83 | 472.1 | 3.21 | 12.3 |
| | butylcatechol | | | | | | | |
| C16 | 1 phr THAP | N.M. | 3.6 | 47.7 | 4.91 | 465.1 | 5.03 | 9.9 |
| C17 | 1 phr L270 | 149 | 3.8 | 38.56 | 3.99 | 220.3 | 7.56 | 11.0 |
| C18 | 1 phr CHP | 10.81 | 5.7 | 87.97 | 8.92 | 471 | 3.5 | 13.5 |
| C19 | 1 phr DiAP | N.M. | 6.4 | 93.2 | 9.43 | 463.1 | 2.73 | 12.6 |
| C20 | 1 phr | N.M. | 5.8 | 105.95 | 10.69 | 487.5 | 1.78 | 12.8 |
| | Trigonox T | | | | | | | |
| Example 1 | 0.3 phr THBP | N.M. | 3.7 | 49.46 | 4.96 | 456.6 | 0.22 | 6.5 |
| | 0.9 phr L231 | | | | | | | |
| Example 2 | 0.1 phr THBP | N.M. | 5.1 | 55.32 | 5.55 | 500.3 | 0.21 | 6.8 |
| | 0.9 phr L231 | | | | | | | |
| Example 3 | 0.1 phr Propyl | N.M. | 5.6 | 61.86 | 6.08 | 480 | 0.11 | 6.5 |
| | Gallate 0.9 phr | | | | | | | |
| | L231 | | | | | | | |
| Example 4 | 0.2 phr Propyl | N.M. | 5.0 | 56.07 | 5.63 | 491.3 | 0.19 | 6.8 |
| | Gallate 0.9 phr | | | | | | | |
| | L231 | | | | | | | |
| Example 5 | 0.3 phr Propyl | N.M. | 4.1 | 49.2 | 4.92 | 490.1 | 0.16 | 6.7 |
| | Gallate 0.9 phr | | | | | | | |
| | L231 | | | | | | | |
| Example 6 | 0.1 phr Propyl | N.M. | 5.7 | 63.37 | 6.2 | 479.3 | 0.09 | 6.5 |
| | Gallate 0.7 phr | | | | | | | |
| | L231 | | | | | | | |
| Example 7 | 0.5 phr Propyl | 6.13 | 2.7 | 39.97 | 4.1 | 431 | 0.47 | 7.6 |
| | Gallate 0.9 phr | | | | | | | |
| | L231 | | | | | | | |
| Example 8 | 0.1 phr | N.M. | 5.4 | 60.13 | 6.09 | 490.2 | 0.42 | 7.3 |
| | Catechol | | | | | | | |
| | 0.9 phr L231 | | | | | | | |
| Example 9 | 0.1 phr | N.M. | 5.4 | 57.89 | 5.85 | 489.4 | 0.28 | 6.9 |
| | Pyrogallol | | | | | | | |
| | 0.9 phr L231 | | | | | | | |
| Example 10 | 0.1 phr THBP | N.M. | 5.1 | 55.32 | 5.55 | 500.3 | 0.21 | 6.8 |
| | 0.9 phr L231 | | | | | | | |
| Example 11 | 0.1 phr NC | N.M. | 5.5 | 59.41 | 5.92 | 512.3 | 0.16 | 6.9 |
| | 0.9 phr L231 | | | | | | | |
| Example 12 | 0.1 phr TBC | N.M. | 5.7 | 63.82 | 6.33 | 489.8 | 0.13 | 6.9 |
| | 0.9 phr L231 | | | | | | | |
| Example 13 | 0.1 phr THAP | N.M. | 4.5 | 52.5 | 5.31 | 485.6 | 0.31 | 6.8 |
| | 0.9 phr L231 | | | | | | | |
| Example 14 | 0.5 phr | 10.73 | 1.9 | 38.36 | 3.95 | 449.5 | 0.80 | 8.5 |
| | Pyrogallol | | | | | | | |
| | 0.9 phr L231 | | | | | | | |
| Example 15 | 0.5 phr THBP | 28.91 | 1.8 | 26.65 | 2.79 | 259.9 | 4.32 | 8.9 |
| | 0.9 phr L231 | | | | | | | |
| Example 16 | 0.5 phr | 11.98 | 4.7 | 51.84 | 5.3 | 474.8 | 0.65 | 8.4 |
| | Catechol | | | | | | | |
| | 0.9 phr L231 | | | | | | | |
| C22 | 1 phr 2,4- | N.M. | 3.5 | 58.75 | 6.0 | 452.6 | 11.45 | 16.62 |
| | pentanedione | | | | | | | |
| | “AcAc” | | | | | | | |
| Example 17 | 0.1 phr AcAc | N.M. | 6.0 | 64.13 | 6.31 | 487.7 | 0.07 | 6.5 |
| | 0.9 phr L231 | | | | | | | |
| Example 18 | 0.2 phr AcAc | N.M. | 5.9 | 65.6 | 6.42 | 486 | 0.13 | 7.0 |
| | 0.9 phr L231 | | | | | | | |
| Example 19 | 0.3 phr AcAc | N.M. | 5.6 | 62.34 | 6.25 | 482.9 | 0.20 | 7.1 |
| | 0.9 phr L231 | | | | | | | |
| Example 20 | 0.5 phr AcAc | N.M. | 5.1 | 63.14 | 6.41 | 470.7 | 0.17 | 7.6 |
| | 0.9 phr L231 | | | | | | | |
| C21 | 1 phr | N.M. | 3.6 | 135.87 | 13.7 | 455.7 | 9.48 | 17.0 |
| | Avobenzone | | | | | | | |
| Example 21 | 0.5 phr | N.M. | 5.5 | 64.85 | 6.53 | 479 | 0.14 | 7.6 |
| | Avobenzone | | | | | | | |
| | 0.9 L231 | | | | | | | |
| Example 22 | 0.1 phr | N.M. | 6.4 | 73.66 | 7.34 | 474.5 | 0.04 | 7.5 |
| | Avobenzone | | | | | | | |
| | 0.9 L231 | | | | | | | |
| Example 23 | 0.5 phr | N.M. | 3.8 | 45.3 | 4.62 | 477.3 | 0.53 | 7.4 |
| | Pyrogallol | | | | | | | |
| | 0.9 phr L231 | | | | | | | |
| Example 24 | 0.5 phr Propyl | N.M. | 3.8 | 43.3 | 4.42 | 480.2 | 0.42 | 6.9 |
| | Gallate 0.9 phr | | | | | | | |
| | L231 | | | | | | | |
| Example 25 | 0.5 phr THBP | N.M. | 2.3 | 35.2 | 3.63 | 468.9 | 0.96 | 7.0 |
| | 0.9 phr L231 | | | | | | | |
| C23 | 0.5 phr | N.M. | 4.9 | 53.4 | 5.46 | 485.3 | 0.61 | 8.7 |
| | Catechol | | | | | | | |
| | 0.9 phr L231 | | | | | | | |
| C24 | 1 phr Methyl | N.M. | 4.2 | 97.2 | 9.84 | 488.2 | 4.34 | 15.3 |
| | Salicylate | | | | | | | |
| C25 | 1 phr Salicylic | 0.99 | 3.2 | 65.6 | 6.69 | 481.5 | 5.86 | 12.6 |
| | Acid | | | | | | | |
| C26 | 1 phr 3-Methly | 2.11 | 3.8 | 71.9 | 7.32 | 476.2 | 5.67 | 12.9 |
| | Salicylic Acid | | | | | | | |
| C27 | 1 phr 5- | 16.10 | 3.1 | 71.4 | 7.26 | 443.9 | 5.18 | 12.6 |
| | Methoxy | | | | | | | |
| | Salicylic Acid | | | | | | | |
| Example 26 | 0.1 phr Methyl | N.M. | 7.0 | 71.0 | 7.10 | 501.3 | 0.05 | 7.3 |
| | Salicylate | | | | | | | |
| | 0.9 phr L231 | | | | | | | |
| Example 27 | 0.1 phr | N.M. | 6.6 | 67.4 | 6.80 | 490.6 | 0.04 | 6.9 |
| | Salicylic Acid | | | | | | | |
| | 0.9 phr L231 | | | | | | | |
| Example 28 | 0.1 phr 3- | N.M. | 6.8 | 70.6 | 7.08 | 484.7 | 0.04 | 7.2 |
| | Methyl | | | | | | | |
| | Salicylic Acid | | | | | | | |
| | 0.9 phr L231 | | | | | | | |
| Example 29 | 0.1 phr 5- | N.M. | 6.7 | 69.4 | 6.92 | 489.4 | 0.04 | 7.1 |
| | Methoxy | | | | | | | |
| | Salicylic Acid | | | | | | | |
| | 0.9 phr L231 | | | | | | | |
| C28 | 1 phr | N.M. | 6.4 | 69.7 | 7.01 | 480.9 | 0.04 | 7.2 |
| | Salicylaldehyde | | | | | | | |
| Example 30 | 0.1 phr | 14.86 | 6.6 | 73.1 | 7.20 | 468.7 | 0.05 | 7.4 |
| | Salicylaldehyde | | | | | | | |
| | 0.9 phr L231 | | | | | | | |
| Example 31 | 0.1 phr | 9.00 | 4.4 | 74.3 | 7.56 | 439.3 | 5.99 | 13.8 |
| | Pyrogallol | | | | | | | |
| | 0.9 phr L230 | | | | | | | |
| C29 | 0.1 phr | 28.76 | 6.3 | 92.5 | 9.37 | 454.3 | 3.71 | 14.2 |
| | Pyrogallol | | | | | | | |
| | 0.9 phr L270 | | | | | | | |
| C30 | 0.1 phr | 12.95 | 6.8 | 88.3 | 8.96 | 465.7 | 3.09 | 13.6 |
| | Pyrogallol | | | | | | | |
| | 0.9 phr CHP | | | | | | | |
| C31 | 0.1 phr | N.M. | 5.7 | 82.6 | 8.39 | 454.9 | 5.20 | 14.6 |
| | Pyrogallol | | | | | | | |
| | 0.9 phr DiAP | | | | | | | |
| C32 | 0.1 phr | 9.91 | 6.0 | 97.6 | 9.86 | 471.3 | 2.46 | 12.4 |
| | Pyrogallol | | | | | | | |
| | 0.9 phr | | | | | | | |
| | Trigonox T | | | | | | | |
| C33 | 0.1 phr | 9.91 | 6.0 | 97.6 | 9.86 | 471.3 | 2.46 | 12.4 |
| | Pyrogallol + | | | | | | | |
| | 0.9 phr MEKP | | | | | | | |

### Preparatory Example 4: Preparation of Stock Solutions Containing CELLOXIDE 2021P and Additives

To determine if the accelerator component of this disclosure showed cure acceleration with the cycloaliphatic type epoxies, stock solutions based on the cycloaliphatic diepoxide, CELLOXIDE 2012P, were prepared. The CELLOXIDE-additive stock solutions shown in Table 5 were created by combining CELLOXIDE 2021P and the desired additive in a glass jar. The mixture was hand stirred with a wooden applicator stick before being placed in a pre-heated 70° C. oven (Despatch LFD1-42-3 Lakeville, Minn.) for 1.5 hours with occasional hand stirring. After heating, each CELLOXIDE-additive stock solution was transferred to a polypropylene DAC Cup to enable high shear mixing on a Speedmixer (DAC 150.1 FVZ-K FlakTek Inc. Landrum S.C.) prior to every use. The high-shear mix conditions were 20 seconds at 1500 rpm.

TABLE 5
CELLOXIDE containing stock solution formulations

| | Celloxide | Additive | Additive, |
|---|---|---|---|
| Stock | 2021, g | Identity | g |
| CELLOXIDE- | 19.99 | Pyrogallol | 0.2002 |
| Pyrogallol Stock | | | |
| CELLOXIDE-Propyl | 20.0200 | Propyl Gallate | 0.2005 |
| Gallate Stock | | | |

### Preparation of Examples 32-33 and Comparative Examples C34-C37: Sample Formulations Containing CELLOXIDE 2021P and Additives

All formulations were created by following the formulation preparation from Example 1. CELLOXIDE 2021P or the CELLOXIDE-additive stock solutions from Table 5 were used as the epoxy component for these formulations.

TABLE 6
Example and Comparative Example formulations

| | | Prop. | Celloxide | | | | |
|---|---|---|---|---|---|---|---|
| | COM, | Carb., | 2021P | | Additive | | Additive |
| Example | g | g | Mass, g | Additive 1 | 1 Mass, 2 | Additive 2 | 2 Mass, g |
| C34 | 0.0507 | 0.0707 | 4.9982 | — | — | — | — |
| C35 | 0.0496 | 0.0763 | 5.0236 | — | — | L231 | 0.0506 |
| C36 | 0.0506 | 0.0693 | — | CELLOXIDE- | 5.00901 | — | — |
| | | | | Pyrogallol | | | |
| | | | | Stock | | | |
| C37 | 0.0496 | 0.0696 | — | CELLOXIDE- | 5.01680 | — | — |
| | | | | Propyl Gallate | | | |
| | | | | Stock | | | |
| Example | 0.0509 | 0.0701 | 4.5210 | CELLOXIDE- | 0.50881 | L231 | 0.0445 |
| 32 | | | | Pyrogallol | | | |
| | | | | Stock | | | |
| Example | 0.0502 | 0.0687 | 4.5311 | CELLOXIDE- | 0.5119 | L231 | 0.0447 |
| 33 | | | | Propyl Gallate | | | |
| | | | | Stock | | | |

The formulations of Table 6 were analyzed by PDSC followed by DSC as described in the general experimental above, and the results are shown in Table 7.

TABLE 7
PDSC and DSC data

| | | PDSC | Visual | TA | TA | | Peak Width | |
|---|---|---|---|---|---|---|---|---|
| | | Exotherm | Onset | Onset | Onset | Exotherm | @ Half | Time to |
| | | Energy, | Temp, | Temp, | Time, | Energy, | Max Height, | 70% Cure, |
| Example | Sample Info | J/g | min | ° C. | min | J/g | min | min |
| C34 | Celloxide | 69.94 | 1.9 | 36.0 | 3.72 | 428.4 | 9.25 | 12.0 |
| | 2021P + 1 phr | | | | | | | |
| | COM | | | | | | | |
| C35 | Celloxide | 46.79 | 2.3 | 35.4 | 3.66 | 448.8 | 9.52 | 12.1 |
| | 2021P + 1 phr | | | | | | | |
| | L231 | | | | | | | |
| C36 | Celloxide | 34.17 | 1.4 | 36.2 | 3.74 | 453.1 | 9.36 | 11.8 |
| | 2021P + 1 phr | | | | | | | |
| | Pyrogallol | | | | | | | |
| C37 | Celloxide | 67.05 | 2.1 | 36.1 | 3.73 | 426.1 | 9.49 | 12.0 |
| | 2021P + 1 phr | | | | | | | |
| | Propyl Gallate | | | | | | | |
| Ex. 32 | 0.1 phr | 22.83 | 2.3 | 35.9 | 3.71 | 514.2 | 9.39 | 12.1 |
| | Pyrogallol + | | | | | | | |
| | 0.9 phr L231 | | | | | | | |
| Ex. 33 | 0.1 phr Propyl | 56.02 | 2.1 | 35.2 | 3.65 | 523.6 | 9.59 | 12.1 |
| | Gallate + 0.9 phr | | | | | | | |
| | L231 | | | | | | | |

### Preparation of Examples 34-36 and Comparative Examples C38-C42

To determine the effect of the accelerator component of this disclosure on organometallic-based thermal acid generators, (mesitylene)₂Fe²⁺ (C(SO₂CF₃)₃)₂ (abbreviated as (mes)2Fe2+) was used as the thermal initiator in the creation of sample formulations. All formulations were created by following the preparation method described for Example 1, with the components used shown in Table 8.

TABLE 8

| | (mes)₂Fe²⁺, | Prop. | Epoxy-1 | | Additive | | Additive |
|---|---|---|---|---|---|---|---|
| Example | g | Carb., g | Mass, g | Additive 1 | 1 Mass, g | Additive 2 | 2 Mass, g |
| C38 | 0.0497 | 0.0685 | 5.0355 | — | — | — | — |
| C39 | 0.0497 | 0.0689 | — | Pyrogallol Stock | 5.0307 | — | — |
| C40 | 0.0495 | 0.0708 | 5.0645 | — | — | L231 | 0.0506 |
| Example 34 | 0.0499 | 0.0701 | 4.5184 | Pyrogallol Stock | 0.5529 | L231 | 0.0431 |
| C41 | 0.0501 | 0.0753 | 5.0166 | Salicylaldehyde | 0.0527 | | — |
| Example 35 | 0.0501 | 0.0762 | 5.0035 | Salicylaldehyde | 0.0050 | L231 | 0.0465 |
| C42 | 0.0499 | 0.0683 | 5.0020 | Methyl | 0.0504 | — | — |
| | | | | Salicylate Stock | | | |
| Example 36 | 0.0501 | 0.020 | 5.0099 | Methyl | 0.0044 | L231 | 0.0448 |
| | | | | Salicylate Stock | | | |

The formulations of Table The formulations of Table 8 were analyzed by PDSC followed by DSC as described in the general experimental above, and the results are shown in Table 9.

TABLE 9

| | | PDSC | Visual | TA | TA | | Peak Width | |
|---|---|---|---|---|---|---|---|---|
| | | Exotherm | Onset | Onset | Onset | Exotherm | @ Half | Time to |
| | | Energy, | Temp, | Temp, | Time, | Energy, | Max Height, | 70% Cure, |
| Example | Sample Info | J/g | min | ° C. | min | J/g | min | min |
| C38 | 1 phr (mes)2Fe2+ | N.M. | 6.7 | 110.0 | 10.90 | 461.1 | 0.89 | 11.9 |
| C39 | 1 phr Pyrogallol + | N.M. | 5.8 | 74.0 | 7.35 | 461.2 | 2.61 | 10.2 |
| | (mes)2Fe2+ | | | | | | | |
| C40 | 1 phr L231 + | N.M. | 6.1 | 81.6 | 8.04 | 482.6 | 0.97 | 9.1 |
| | (mes)2Fe2+ | | | | | | | |
| Example | 0.1 phr Pyrogallol + | N.M. | 5.6 | 66.1 | 6.55 | 468.8 | 0.63 | 8.7 |
| 34 | 0.9 L231 + | | | | | | | |
| | (mes)2Fe2+ | | | | | | | |
| C41 | 1 phr | N.M. | 6.7 | 77.5 | 7.87 | 547.2 | 2.89 | 10.8 |
| | Salicylaldehyde + | | | | | | | |
| | (mes)2Fe2+ | | | | | | | |
| Example | 0.1 phr | N.M. | 7.1 | 89.2 | 8.96 | 553.0 | 0.80 | 9.7 |
| 35 | Salicylaldehyde + | | | | | | | |
| | 0.9 phr L231 + | | | | | | | |
| | (mes)2Fe2+ | | | | | | | |
| C42 | 1 phr Methyl | N.M. | 6.3 | 82.2 | 8.35 | 548.1 | 3.29 | 11.7 |
| | Salicylate + | | | | | | | |
| | (mes)2Fe2+ | | | | | | | |
| Example | 0.1 phr Methyl | N.M. | 6.7 | 89.5 | 9.00 | 555.7 | 0.68 | 9.6 |
| 36 | Salicylate + 0.9 phr | | | | | | | |
| | L231 + | | | | | | | |
| | (mes)2Fe2+ | | | | | | | |

1. A catalyst system comprising:
a) a cationic initiator;
b) an accelerator composition comprising 1) a peroxyketal; and 2) an accelerator compound selected from arylhydroxy compounds and β-diketone compounds.

2. The catalyst system of claim 1 wherein the arylhydroxy compound is of the formula: 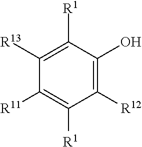
wherein each R¹, independently, can be hydrogen or a group selected from chloro, iodo, bromo, fluoro, cyano, nitro, nitroso, carboxyl, ester, formyl, acetyl, benzoyl, trialkylsilyl, and trialkoxysilyl, a radical moiety selected from substituted and unsubstituted alkyl, alkenyl, alkynyl, and alkoxy groups and R¹¹, R¹² and R¹³ are independently hydroxy, or a carbonyl-containing functional groups.

3. The catalyst system of claim 2 wherein two of R¹¹, R¹² and R¹³ are carbonyl-containing functional groups.

4. The catalyst system of claim 1 wherein the arylhydroxy compound is selected from catechol; pyrogallol; gallic acid; esters of gallic acid; tannins, alkylcatechols, nitrocatechols, alkoxycatechols; 2,3,4-trihydroxybenzophenone; 2,3,4-trihydroxyacetophenone; salicylaldehyde, and methyl salicylate.

5. The catalyst system of claim 1 wherein the β-diketone compounds are of the formula: 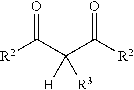
wherein each R² can be the same or different and each R¹, independently, can be hydrogen or a group selected from chloro, iodo, bromo, fluoro, cyano, nitro, nitroso, carboxyl, ester, formyl, acetyl, benzoyl, trialkylsilyl, and trialkoxysilyl, alkyl, alkenyl, alkynyl, alkoxy groups or hydroxy, and R³ can be a substituted or unsubstituted alkyl or aryl group.

6. The catalyst system of claim 1 wherein the β-diketone compounds are selected from 2,4-pentanedione, 3,5-heptanedione, 1,3-diphenyl-1,3-propanedione, 1-phenyl-1,3-butanedione, 1,1,1-trifluoro-2,4-pentanedione, 1,1,1,5,5,5-hexafluoro-2,4-pentanedione, and 1-(4-methoxyphenyl)-3-(4-tert-butylphenyl)propane-1,3-dione.

7. The catalyst system of claim 1 wherein the cationic initiator is of the formula:
[(L¹)(L²)M^{m}]^{+e}X⁻
wherein
M^{m} represents a Cr, Mo, W, Mn, Re, Fe, and Co;
L¹ represents none, one, or two ligands contributing π-electrons;
L² represents none or 1 to 3 ligands contributing an even number of sigma-electrons;
e is an integer having a value of 1 or 2, the residual charge of the complex cation; and
X is a halogen-containing complex anion.

8. The catalyst system of claim 7 wherein the cationic initiator is a cationic photoinitiator.

9. The catalyst system of claim 8 wherein the cationic photoinitiator is selected from η⁵-cyclopentadienyl Fe(xylenes)SbF₆, where Cp=(η⁶-cumene) (η⁵-cyclopentadienyl) iron(II) hexafluorophosphate and (η⁶-cumene) (η⁵-cyclopentadienyl) iron(II) hexafluoroantimonate.

10. The catalyst system of claim 7 wherein the cationic initiator is a cationic thermal initiator.

11. The catalyst system of claim 10 wherein the cationic thermal initiator is one or more selected from the group consisting of bis-arene Fe(II) hexafluoroantimonates and trifluoromethanesulfonates.

12. The catalyst system of claim 1 wherein the peroxy ketal is of the formula:
R⁵R⁶C(O—O—R⁷)₂,
where R⁵ and R⁶ are each alkyl, or may be be taken together to form ring, and each R⁷ is an alkyl group.

13. The catalyst system of claim 1 wherein the peroxy ketal is selected from 1,1-bis(t-butylperoxy)-3,3,5-trimethylcyclohexane, 1,1-bis(t-butylperoxy)cyclohexane, 1,1-bis(t-amylperoxy)-cyclohexane, 2,2-bis(t-butylperoxy)butane, 2,2-bis(t-butylperoxy)octane, ethyl 3,3-bis(t-amylperoxy) butyrate, and 4,4-bis(t-butylperoxy)valeric acid-n-butylester.

14. A curable composition comprising the catalyst system of claim 1 and a cationically polymerizable monomer.

15. The curable composition of claim 14 wherein the cationically polymerizable monomer is selected from epoxy-containing monomers, oxetane-containing monomers and vinyl ether monomers.

16. The curable composition of claim 14 further comprising a (meth)acrylate monomer and a free radical initiator.

17. The curable composition of claim 16 wherein the (meth)acrylate monomer is one or more selected from the group consisting of tert-butyl acrylate, phenoxyethyl acrylate, isobornyl acrylate, 2-hydroxyl-3-phenoxypropyl acrylate, N-vinyl-2-pyrrolidone, and N-vinylcaprolactam.

18. The curable composition of claim 16 wherein the free radical initiator is one or more selected from the group consisting of 2,2-dimethoxy-2-phenyl acetophenone, 1-hydroxylcyclohexylphenylmethanone, 2-hydroxyl-2-methyl-1-phenylpropane-1-one, 2-isopropylthioxanthone, 4-isopropylthioxanthone, 2,4,6-trimethylbenzoyldiphenylphosphine oxide, and bis(2,4,6-trimethylbenzoyl)-phenylphosphine oxide.

19. The curable composition of claim 14 wherein the cationic initiator is in an amount of 0.1 to 5 parts by weight, based on 100 parts total weight of the curable composition.

20. The curable composition of claim 14, comprising a hydroxyaryl compound in amounts of 0.01 to 10.0 weight percent of the total polymerizable composition.

21. The curable composition of claim 14, comprising a beta-diketone compound in amounts of 0.05 to 10.0 weight percent of the total polymerizable composition.

22. The curable composition of claim 14, comprising a peroxyketal in amounts 0.1 to 5.0 weight percent of the total polymerizable composition.
